(19) United States
(12) Patent Application Publication
(10) Pub. No.: US 2012/0177915 A1
(43) Pub. Date: Jul. 12, 2012

(54) LUBRICANT COMPOSITION AND SLIDING MECHANISM USING THE LUBRICANT COMPOSITION

(75) Inventors: Moritsugu Kasai, Chiba (JP); Ryou Yamada, Chiba (JP); Masanori Tsujioka, Hyogo (JP); Koji Miyake, Kyoto (JP)

(73) Assignees: NIPPON ITF INC., Kyoto-shi (JP); IDEMITSU KOSAN CO., LTD., Tokyo (JP)

(21) Appl. No.: 13/395,801

(22) PCT Filed: Sep. 13, 2010
(86) PCT No.: PCT/JP10/65747

§ 371 Date: Mar. 13, 2012

(30) Foreign Application Priority Data
Sep. 15, 2009 (JP) 2009-213647
Jun. 1, 2010 (JP) 2010-126367
Jun. 1, 2010 (JP) 2010-126368

(51) Int. Cl. C10M 135/20; C10M 137/10; B32B 15/04; C10M 137/06

(52) U.S. Cl. 428/336; 508/431; 508/371; 508/465; 508/109; 428/408

(57) ABSTRACT

Provided by the present invention is a lubricating oil composition showing a very low frictional coefficient when used as a lubricating oil for a low friction sliding material prepared by blending with an additive selected from a specific phosphorus-zinc-containing compound and a specific sulfur-containing compound, and a sliding mechanism having an excellent low frictional property in which a DLC film containing 5 to 50 atom % of hydrogen is formed or a sliding mechanism having an excellent low frictional property in which 1 to 30 atom % of tungsten (W) or molybdenum (Mo) is contained is provided by combining the above lubricating oil composition with a sliding member having a film of a specific low frictional sliding material on a sliding face.

### BACKGROUND OF THE INVENTION

The present invention relates to a lubricating oil composition and a sliding mechanism prepared by using the above lubricating oil composition, more specifically to a lubricating oil composition showing a very low friction coefficient when used as a lubricating oil for a low friction sliding material and a sliding mechanism showing a low frictional coefficient which is prepared by using the above lubricating oil composition.

### RELATED ART

In recent years, it is important to meet environmental problems in various fields, and technical development on energy saving and a reduction in a discharge amount of carbon dioxide is promoted. In a case of, for example, automobiles, a rise in a fuel consumption is one of problems, and technical development of lubricating oils and sliding materials becomes important.

In respect to lubricating oils, various base oils and additives have so far been developed for the purpose of enhancing various performances. For example, performances required to engine oils include an appropriate viscosity characteristic, an oxidation stability, a clean dispersibility, an abrasion preventing property, a bubbling preventing property and the like, and the above performances are attempted to be elevated by combination of various base oils and additives. In particular, zinc dialkyldithiophosphate (ZnDTP) is excellent as an abrasion resistant additive and therefore is used well as an additive for engine oils.

On the other hand, in respect to sliding materials, materials having a hard film such as a TiN film, a CrN film and the like which contribute to a rise in an abrasion resistance are known as materials for parts which are exposed to severe frictional abrasion environment (for example, a sliding part of an engine). Further, it is known that a friction coefficient can be reduced in the air under the absence of a lubricating oil by making use of a diamond-like carbon (DLC) film, and materials having a DLC film (hereinafter referred to as a DLC material) are expected as a low friction sliding material.

However, a friction reducing effect of a DLC material is small under the presence of a lubricant oil in a certain case, and in the above case, a fuel consumption saving effect is less liable to be obtained. Accordingly, development of a lubricating oil composition for a low friction sliding material such as DLC materials and the like has so far been carried out.

A lubricating oil composition which contains an ether base ashless friction reducing agent and which is used for a low friction sliding member is disclosed in, for example, a patent document 1. Disclosed in patent documents 2 and 3 are techniques in which lubricating oil compositions containing fatty acid ester base ashless friction controlling agents and aliphatic amine base ashless friction controlling agents are used for a sliding face between a DLC member and an iron base member and a sliding face between a DLC member and an aluminum alloy member. Disclosed in patent document 4 is a technique in which a low friction agent composition containing an oxygen-containing organic compound and an aliphatic amine base compound is used in a low friction sliding mechanism having a DLC coating sliding member.

As described above, lubricating oil compositions for low friction sliding materials have been developed, but even in a case in which the above techniques are applied, the friction coefficient tends to grow larger when ZnDTP is blended in order to enhance further the abrasion resistance and the like. Accordingly, required is a lubricating oil composition which can maintain various performances required to lubricating oils without using ZnDTP and which shows a very low friction coefficient particularly when used as a lubricating oil for a low friction sliding material.

Required is a sliding mechanism which is combined with a sliding member having the DLC film described above on a sliding face by using a lubricating oil composition capable of exerting an excellent low friction property while maintaining various performances as the above lubricating oil and which is excellent in a low friction property.
Patent document 1: Japanese Patent Application Laid-Open No. 36850/2006
Patent document 2: Japanese Patent Application Laid-Open No. 238982/2003
Patent document 3: Japanese Patent Application Laid-Open No. 155891/2004
Patent document 4: Japanese Patent Application Laid-Open No. 98495/2005

### DISCLOSURE OF THE INVENTION

The present invention has been made in light of the situations described above, and an object of the present invention is to provide a lubricating oil composition showing a very low friction coefficient when used as a lubricating oil for a low friction sliding material. Further, an object of the present invention is to provide a sliding mechanism which is excellent in a low friction property by combining with a sliding member having a specific film of a low friction sliding material on a sliding face by using a lubricating oil composition capable of exerting an excellent low friction property while maintaining various performances as a lubricating oil.

Researches repeated intensely by the present inventors have resulted in finding that an excellent low friction property can be exerted while maintaining various performances as the lubricating oil described above by a lubricating oil composition prepared by blending with a specific additive and that the problems described above are solved by constituting a sliding mechanism by a lubricating oil comprising the above lubricating oil composition and a sliding member on which a DLC film prepared by adding a specific component is formed. The present invention has been completed based on the above knowledge.

That is, the present invention provides:

1. a lubricating oil composition (referred to as an invention 1) used for a low friction sliding material, prepared by blending with an additive selected from a phosphorus-zinc-containing compound obtained by reacting a phosphorus-containing compound represented by Formula (I) with a zinc compound:

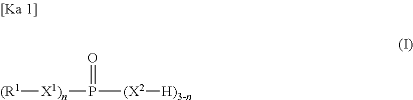

(wherein X¹ and X² represent an oxygen atom or a sulfur atom; R¹ represents an organic group having 2 to 30 carbon atoms which contains an oxygen atom or a sulfur atom; and n is an integer selected from 1 to 3) and a sulfur-containing compound represented by Formula (II):

[Ka 2]

R²-A¹-Sₙ-A²-R³ (II)

(wherein n is an integer selected from 1 to 5; R² and R³ each represent independently an organic group having 1 to 30 carbon atoms which may contain an atom selected from an oxygen atom, a sulfur atom and a nitrogen atom; and A¹ and A² each represent independently a divalent hydrocarbon group having 1 to 20 carbon atoms),
2. the lubricating oil composition according to the item 1 described above, wherein the additive is the phosphorus-zinc-containing compound obtained by using the phosphorus-containing compound in which at least one of X¹ and X² in Formula (I) is an oxygen atom,
3. the lubricating oil composition according to the item 1 described above, wherein the additive is a phosphorus-zinc-containing compound obtained by using a phosphorus-containing compound represented by Formula (III):

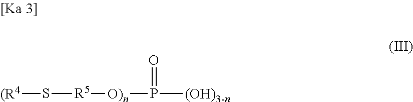

(wherein R⁴ represents an organic group having 4 to 24 carbon atoms; R⁵ represents a divalent organic group having 1 to 6 carbon atoms; and n is an integer selected from 1 to 3),
4. the lubricating oil composition according to the item 1 described above, wherein the additive is a sulfur-containing compound represented by Formula (IV):

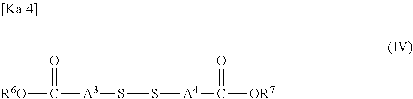

(wherein R⁶ and R⁷ each represent independently an organic group having 1 to 29 carbon atoms which may contain an atom selected from an oxygen atom, a sulfur atom and a nitrogen atom; and A³ and A⁴ each represent independently a divalent hydrocarbon group having 1 to 12 carbon atoms),
5. the lubricating oil composition according to the item 1 described above, wherein the low friction sliding material is a material having a diamond-like carbon (DLC) film,
6. a sliding mechanism (referred to as an invention 2) in which the lubricating oil composition according to the item 1 is allowed to be present on sliding faces of two sliding members sliding with each other, wherein a DLC film containing 5 to 50 atom % of hydrogen is formed on a sliding face of at least one of the two sliding members,
7. the sliding mechanism according to the item 6 described above, wherein the DLC film is a DLC film having a graphite crystal peak in an X ray scattering spectrum,
8. the sliding mechanism according to the item 7 described above, wherein a crystal diameter of the graphite crystal in the DLC film is 15 to 100 nm,
9. the sliding mechanism according to the item 7 described above, wherein a metal layer, a metal nitride layer or a metal carbide layer comprising at least one selected from titanium (Ti), chromium (Cr), tungsten (W) and silicon (Si) is provided between the sliding member and the DLC film,
10. the sliding mechanism according to the item 7 described above, wherein the DLC film is formed by a cathode PIG plasma CVD method under high density plasma environment,
11. a sliding mechanism (referred to as an invention 3) in which a lubricating oil is allowed to be present on sliding faces of two sliding members sliding with each other, wherein the lubricating oil is constituted from a lubricating oil composition prepared by blending with an additive selected from a phosphorus-zinc-containing compound obtained by reacting a phosphorus-containing compound represented by Formula (I) with a zinc compound:

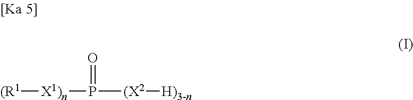

(wherein X¹ and X² represent an oxygen atom or a sulfur atom; R¹ represents an organic group having 2 to 30 carbon atoms which contains an oxygen atom or a sulfur atom; and n is an integer selected from 1 to 3) and a sulfur-containing compound represented by Formula (II):

[Ka 6]

R²-A¹-Sₙ-A²-R³ (II)

(wherein n is an integer selected from 1 to 5; R² and R³ each represent independently an organic group having 1 to 30 carbon atoms which may contain an atom selected from an oxygen atom, a sulfur atom and a nitrogen atom; and A¹ and A² each represent independently a divalent hydrocarbon group having 1 to 20 carbon atoms); a DLC film is formed on a sliding face of at least one of the two sliding members; and 1 to 30 atom % of tungsten (W) or molybdenum (Mo) is contained in the above DLC film,
12. the sliding mechanism according to the item 11 described above, wherein an intermediate layer is provided between the sliding member and the DLC film; the above intermediate layer comprises any one layer or two or more layers of a metal layer, a metal nitride layer or a metal carbide layer of any metals selected from titanium (Ti), chromium (Cr), tungsten (W) and silicon (Si); and a total thickness of the intermediate layer is 0.1 to 2.0 μm,
13. the sliding mechanism according to the item 12 described above, wherein the DLC film has therein a carbon layer having a graphite crystal peak in an X ray scattering spectrum,
14. the sliding mechanism according to the item 13 described above, wherein the additive is the phosphorus-zinc-containing compound obtained by using the phosphorus-containing compound in which at least one of X¹ and X² in Formula (I) is an oxygen atom,
15. the sliding mechanism according to the item 14 described above, wherein the additive is a phosphorus-zinc-containing compound obtained by using a phosphorus-containing compound represented by Formula (III):

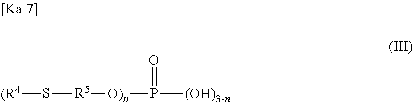

(wherein R⁴ represents an organic group having 4 to 24 carbon atoms; R⁵ represents a divalent organic group having 1 to 6 carbon atoms; and n is an integer selected from 1 to 3),
16. the sliding mechanism according to the item 15 described above, wherein the additive is a sulfur-containing compound represented by Formula (IV):

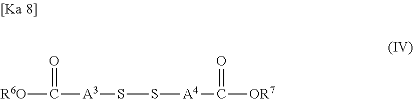

(wherein R⁶ and R⁷ each represent independently an organic group having 1 to 29 carbon atoms which may contain an atom selected from an oxygen atom, a sulfur atom and a nitrogen atom; and A³ and A⁴ each represent independently a divalent hydrocarbon group having 1 to 12 carbon atoms).

According to the present invention 1, capable of being provided is a lubricating oil composition showing a very low friction coefficient when used as a lubricating oil for a low friction sliding material. Further, according to the present inventions 2 and 3, sliding mechanisms 1 and 2 which are excellent in a low friction property can be provided in combination of the lubricating oil composition described above with a sliding face on which a film of a specific low friction sliding material is provided.

### BRIEF EXPLANATION OF DRAWINGS

FIG. 1 is a cross-sectional drawing schematically showing the structures of the sliding members having a DLC film in the sliding mechanisms 1 and 2 according to one embodiment of the present inventions 2 and 3.

FIG. 2 is a cross-sectional drawing schematically showing the structures of the sliding members having a DLC film in the sliding mechanisms 1 and 2 according to another embodiment of the present inventions 2 and 3.

FIG. 3 is a drawing showing an outline of a cathode PIG plasma CVD equipment which is one example of a forming equipment of the DLC film according to one embodiment of the present inventions 2 and 3.

FIG. 4 is a measurement example of an X ray diffraction spectrum of the DLC film according to one embodiment of the present inventions 2 and 3.

FIG. 5 is a differential spectrum of the DLC film in FIG. 4.

FIG. 6 is a drawing showing crystal peak extraction of the DLC film in FIG. 4.

### EXPLANATION OF CODES

1, 41: Base material
2: Intermediate layer
3: DLC film
4: Graphite crystal
21: Base layer
40: Chamber
42: Holder
43: Plasma source
44: Electrode
45: Coil
46: Cathode
47: Gas introducing inlet
48: Gas discharging port
49: Bias electric source
50: Plasma

### MODE FOR CARRYING OUT THE INVENTION

The present invention relates to a lubricating oil composition (invention 1) and sliding mechanisms (inventions 2 and 3) prepared by using the above lubricating oil composition. They shall be explained below in detail.

First, the invention 1 shall be explained.

### <Lubricating Oil Composition>

The lubricating oil composition of the present invention 1 contains a lubricating oil base oil and a specific additive and is used as a lubricating oil used for a sliding face of a low friction sliding material.

The lubricating oil base oil used in the present invention 1 shall not specifically be restricted, and base oils suitably selected from publicly known mineral base oils and synthetic base oils which have so far been used can be used.

In this regard, capable of being listed as the mineral oils are, for example, distillate oils obtained by distilling paraffin base crude oils, intermediate base crude oils or naphthene base crude oils at atmospheric pressure or distilling residual oils of atmospheric distillation under reduced pressure, or refined oils obtained by refining the above distillate oils according to an ordinary method, for example, solvent-refined oils, hydrogenation-refined oils, dewaxing-treated oils, white clay-treated oils and the like.

On the other hand, poly-α-olefins which are α-olefin oligomers having 8 to 14 carbon atoms, polybutene, polyol esters, alkylbenzenes and the like can be listed as the synthetic oils.

In the present invention 1, the mineral oils described above may be used alone or in combination of two or more kinds thereof as the base oil. Also, the synthetic oils described above may be used alone or in combination of two or more kinds thereof as the base oil. Further, at least one mineral oil and at least one synthetic oil may be used in combination.

It is advantageous that the base oil described above has a kinetic viscosity of usually 2 to 50 mm²/s, preferably 3 to 30 mm²/s and particularly preferably 3 to 15 mm²/s at 100° C. If the kinetic viscosity at 100° C. is 2 mm²/s or more, the vaporization loss is small. On the other hand, if it is 50 mm²/s or less, the power loss brought about by the viscosity resistance is inhibited, and the fuel consumption-improving effect is exerted well.

Further, the above base oil has a viscosity index of preferably 60 or more, more preferably 70 or more and particularly preferably 80 or more. If the viscosity index is 60 or more, a viscosity change of the base oil brought about by temperature is small, and the stable lubricating performance is exerted.

In the present invention 1, a phosphorus-zinc-containing compound obtained by reacting a specific phosphorus-containing compound with a zinc compound or a specific sulfur-containing compound is used as the additive. The above additives not only have an abrasion resistant effect but also contribute to a reduction in the frictional coefficient.

The phosphorus-zinc-containing compound used in the present invention 1 is prepared by using the phosphorus-containing compound represented by Formula (I):

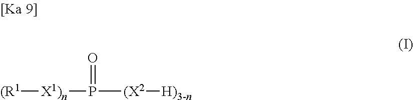

In Formula (I), X¹ and X² represent an oxygen atom or a sulfur atom; R¹ represents an organic group having 2 to 30 carbon atoms which contains an oxygen atom or a sulfur atom; and n is an integer selected from 1 to 3. In particular, the compound in which at least one of X¹ and X² is an oxygen atom is preferred.

Among the phosphorus-containing compounds represented by Formula (I), a phosphorus-containing compound represented by Formula (III) is particularly preferred:

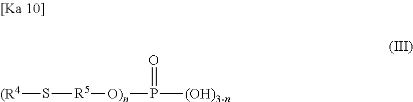

In Formula (III), R⁴ represents an organic group having 4 to 24 carbon atoms; R⁵ represents a divalent organic group having 1 to 6 carbon atoms; and n is an integer selected from 1 to 3.

The organic group represented by R⁴ is preferably a hydrocarbon group having 4 to 24 carbon atoms, and an alkyl group, a cycloalkyl group, an aryl group, an arylalkyl group and the like are used therefor. In particular, an alkyl group having 8 to 16 carbon atoms is preferred. Also, R⁵ is preferably a hydrocarbon group having 1 to 6 carbon atoms, and an alkylene group having 1 to 4 carbon atoms is particularly preferred. To be specific, capable of being listed are divalent aliphatic groups such as methylene, ethylene, 1,2-propylene, 1,3-propylene, various butylenes, various pentylenes, various hexylenes and the like, alicyclic groups which are alicyclic hydrocarbons having two bonding sites, such as cyclohexane, methylcyclohexane and the like and various phenylenes.

The specific examples of the phosphorus-containing compound represented by Formula (I) or Formula (III) include hydrogendi(hexylthioethyl)phosphate, hydrogendi(octylthioethyl)phosphate, hydrogendi(dodecylthioethyl)phosphate, hydrogendi(hexadecylthioethyl)phosphate, hydrogenmono(hexylthioethyl)phosphate, hydrogenmono(octylthioethyl)phosphate, hydrogenmono(dodecylthioethyl)phosphate, hydrogenmono(hexadecylthioethyl)phosphate and the like.

The phosphorus-containing compounds described above can be obtained by, for example, a production method in which alkylthioalkyl alcohol or alkylthioalkoxide is reacted with phosphorus oxychloride (POCl₃) under the absence of a catalyst or the presence of a base.

The zinc compound used for preparing the phosphorus-zinc-containing compound is preferably metal zinc, zinc oxide, organic zinc compounds, zinc oxygen acid salt, zinc halides, zinc complexes and the like, and it includes, to be specific, zinc, zinc oxide, zinc hydroxide, zinc chloride, zinc carbonate, zinc carboxylates, zinc complexes and the like.

The phosphorus-zinc-containing compound can be obtained by reacting the phosphorus-containing compound with the zinc compound under the absence or the presence of a catalyst. In the above reaction, the phosphorus-containing compound is reacted with the zinc compound in a use proportion of preferably 0.55 or more in terms of a mole ratio (Zn/P) of a zinc atom to a phosphorus atom. A use proportion of 0.55 or more provides the sufficiently high extreme pressure property and abrasion resistance and makes the base number-maintaining performance satisfactory, and it is preferably 0.56 to 1, more preferably 0.58 to 1. A use proportion of 1 or less provides the excellent solubility to the base oil. Also, the reaction temperature is selected in a range of usually room temperature to 200° C., preferably 40 to 150° C.

The reaction product thus obtained comprises a zinc salt of the phosphorus-containing compound and the like as principal components, and it is used usually after refined by removing impurities according to an ordinary method.

The sulfur-containing compound used in the present invention 1 is represented by Formula (II):

[Ka 11]

R²-A¹-Sₙ-A²-R³ (II)

In Formula (II), n is an integer selected from 1 to 5; R² and R³ each represent independently an organic group having 1 to 30 carbon atoms which may contain an atom selected from an oxygen atom, a sulfur atom and a nitrogen atom; and A¹ and A² each represent independently a divalent hydrocarbon group having 1 to 20 carbon atoms. Among the sulfur-containing compounds represented by Formula (II), a sulfur-containing compound represented by Formula (IV) is particularly preferred:

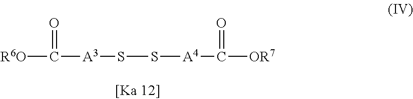

In Formula (IV), R⁶ and R⁷ each represent independently an organic group having 1 to 29 carbon atoms which may contain an atom selected from an oxygen atom, a sulfur atom and a nitrogen atom, and A³ and A⁴ each represent independently a divalent hydrocarbon group having 1 to 12 carbon atoms. R⁶ and R⁷ may be any of a linear group, a branched group and a cyclic group, and they have preferably 1 to 20 carbon atoms, more preferably 2 to 18 carbon atoms and particularly preferably 3 to 18 carbon atoms. Also, A³ and A⁴ are preferably a hydrocarbon group having 1 to 8 carbon atoms.

A production method for the sulfur-containing compound represented by Formula (IV) includes, for example, a production method in which mercaptoalkanecarboxylic acid ester is subjected to oxidative coupling. Oxygen, hydrogen peroxide, dimethyl sulfoxide and the like are used as an oxidizing agent used in the above case.

Capable of being listed as the specific examples of the sulfur-containing compound represented by Formula (II) or (IV) are bis(methoxycarbonylmethyl)disulfide, bis(ethoxycarbonylmethyl)disulfide, bis(n-propoxycarbonylmethyl)disulfide, bis(isopropoxycarbonylmethyl)disulfide, bis(n-butoxycarbonylmethyl)disulfide, bis(n-octoxycarbonylmethyl)disulfide, bis(n-dodecyloxycarbonylmethyl)disulfide, bis(cyclopropoxycarbonylmethyl)disulfide, 1,1-bis(1-methoxycarbonylethyl)disulfide, 1,1-bis(1-methoxycarbonyl-n-propyl)disulfide, 1,1-bis(1-methoxycarbonyl-n-butyl) disulfide, 1,1-bis(1-methoxycarbonyl-n-hexyl)disulfide, 1,1-bis(1-methoxycarbonyl-n-octyl)disulfide, 1,1-bis(1-methoxycarbonyl-n-dodecyl)disulfide, 2,2-bis(2-methoxycarbonyl-n-propyl)disulfide, α,α-bis(α-methoxycarbonylbenzyl)disulfide, 1,1-bis(2-methoxycarbonylethyl)disulfide, 1,1-bis(2-ethoxycarbonylethyl)disulfide, 1,1-bis(2-n-propoxycarbonylethyl)disulfide, 1,1-bis(2-isopropoxycarbonylethyl)disulfide, 1,1-bis(2-cyclopropoxycarbonylethyl)disulfide, 1,1-bis(2-methoxycarbonyl-n-propyl)disulfide, 1,1-bis(2-methoxycarbonyl-n-butyl)disulfide, 1,1-bis(2-methoxycarbonyl-n-hexyl)disulfide, 1,1-bis(2-methoxycarbonyl-n-propyl)disulfide, 2,2-bis(3-methoxycarbonyl-n-pentyl)disulfide, 1,1-bis(2-methoxycarbonyl-1-phenylethyl)disulfide and the like.

The blending amounts of the phosphorus-zinc-containing compound and the sulfur-containing compound each described above are usually 0.05 to 5% by mass, preferably 0.1 to 4% by mass based on a whole amount of the composition. If the blending amount is 0.05 by mass or more, the sufficiently high abrasion resistance is obtained, and if it is 5% by mass or less, corrosion is not likely to be brought about. Since in the present invention 1, the abrasion resistance is enhanced by the above additives, the lubrication oil composition having satisfactory properties is obtained without using ZnDTP, and the low friction coefficient is obtained even when it is used for the low friction sliding material.

Thus, in the lubrication oil composition of the present invention, a blending amount of ZnDTP is preferably small from the viewpoint of a reduction in the friction coefficient, and it is usually 0.06% by mass or less in terms of a phosphorus amount. It is particularly preferably not blended.

The lubrication oil composition of the present invention 1 may be blended with additives which have so far been publicly known as long as the effects of the present invention are not damaged, and they include, for example, metal base cleaning agents, ashless dispersants, friction-reducing agents, viscosity index-improving agents, pour point depressants, antioxidants, rust preventives and the like.

The metal base cleaning agents include alkaline earth metal sulfonates, salicylates, finates and the like. Among them, alkaline earth metal sulfonates and salicylates are preferred from the viewpoint of a reduction in the friction.

The ashless dispersants include, for example, succinimides, boron-containing succinimides, benzylamines, boron-containing benzylamines, succinic esters and amides of monovalent or divalent carboxylic acids represented by fatty acids or succinic acid. Among them, succinimides containing no boron are preferred from the viewpoint of a reduction in the friction.

The friction-reducing agents include ashless friction-reducing agents such as fatty acid esters, aliphatic amines, higher alcohols and the like. Capable of being shown as the examples of the viscosity index-improving agents are, to be specific, so-called non-dispersion type viscosity index-improving agents such as copolymers according to various methacrylic esters or optional combinations thereof and hydrogenated products thereof and so-called dispersion type viscosity index-improving agents obtained by copolymerizing various methacrylic esters including nitrogen compounds. Also, capable of being shown as the examples thereof are non-dispersion type or dispersion type ethylene-α-olefin copolymers (the α-olefin includes, for example, propylene, 1-butene, 1-pentene and the like) and hydrogenated products thereof, polyisobutylene and hydrogenated products thereof, styrene-diene hydrogenated copolymers, styrene-maleic anhydride ester copolymers, polyalkylstyrene and the like. The molecular weights of the above viscosity index-improving agents have to be selected considering the shearing stability. To be specific, a number average molecular weight of the above viscosity index-improving agents is 5000 to 1000000, preferably 100000 to 800000 in a case of, for example, dispersion type or non-dispersion type polymethacrylates; 800 to 5000 in a case of polyisobutylene or hydrogenated products thereof; and 800 to 300000, preferably 10000 to 200000 in a case of ethylene-α-olefin copolymers and hydrogenated products thereof. Also, the above viscosity index-improving agents can be added alone or in optional combination of plural kinds thereof, and a content thereof is usually 0.1 to 40.0% by mass based on a whole amount of the lubricating oil composition. The pour point-depressants include, for example, polymethacrylates.

The antioxidant includes phenol base antioxidants and amine base antioxidants. The phenol base antioxidants include, for example, 4,4′-methylenebis(2,6-di-t-butylphenol); 4,4′-bis(2,6-di-t-butylphenol); 4,4′-bis(2-methyl-6-t-butylphenol); 2,2′-methylenebis(4-ethyl-6-t-butylphenol); 2,2′-methylenebis(4-methyl-6-t-butylphenol); 4,4′-butylidenebis(3-methyl-6-t-butylphenol); 4,4′-isopropylidenebis(2,6-di-t-butylphenol); 2,2′-methylenebis(4-methyl-6-nonylphenol); 2,2′-isobutylidenebis(4,6-dimethylphenol); 2,2′-methylenebis(4-methyl-6-cyclohexylphenol); 2,6-di-t-butyl-4-methylphenol; 2,6-di-t-butyl-4-ethylphenol; 2,4-dimethyl-6-t-butylphenol; 2,6-di-t-amyl-p-cresol; 2,6-di-t-butyl-4-(N,N′-dimethylaminomethylphenol; 4,4′-thiobis(2-methyl-6-t-butylphenol); 4,4′-thiobis(3-methyl-6-t-butylphenol); 2,2′-thiobis(4-methyl-6-t-butylphenol); bis(3-methyl-4-hydroxy-5-t-butylbenzyl)sulfide; bis(3,5-di-t-butyl-4-hydroxybenzyl)sulfide; n-octadecyl-3-(4-hydroxy-3,5-di-t-butylphenyl)propionate; 2,2′-thio[diethyl-bis-3-(3,5-di-t-butyl-4-hydroxyphenyl)propionate] and the like. Among them, bisphenol base and ester group-containing phenol base antioxidants are particularly preferred.

The amine base antioxidants include, for example, monoalkyldiphenylamines such as monooctyldiphenylamine, monononyldiphenylamine and the like; dialkyldiphenylamines such as 4,4′-dibutyldiphenylamine, 4,4′-dipentyldiphenylamine, 4,4′-dihexyldiphenylamine, 4,4′-diheptyldiphenylamine, 4,4′-diocyldiphenylamine, 4,4′-dinonyldiphenylamine and the like; polyalkyldiphenylamines such as tetrabutyldiphenylamine, tetrahexyldiphenylamine, tetraocyldiphenylamine, tetranonyldiphenylamine and the like; naphthyl amine base antioxidants, to be specific, α-naphthylamine, phenyl-α-naphthylamine and alkyl-substituted phenyl-α-naphthylamines such as butylphenyl-α-naphthylamine, pentylphenyl-α-naphthylamine, hexylphenyl-α-naphthylamine, heptylphenyl-α-naphthylamine, octylphenyl-α-naphthylamine, nonylphenyl-α-naphthylamine and the like. Among them, the dialkyldiphenylamine base antioxidants and the naphthylamine base antioxidants are suited.

The rust preventives include alkylbenzenesulfonates, dinonylnaphthalenesulfonates, alkenylsuccinic esters, polyhydric alcohol esters and the like.

The invention 1 has been explained above.

Principally, the invention 2 shall be explained below.

The lubricating oil composition of the present invention 1 described above is applied to a sliding face having a low friction sliding material and can provide the sliding mechanism (invention 2) with an excellent low friction property and an excellent abrasion resistance, and particularly when applied to internal combustion engines, they can be provided with a fuel consumption-saving effect.

The sliding face having a low friction sliding material described above is preferably a sliding face having a DLC material as the low friction sliding material at east at one side thereof. In this case, a material of the other sliding face includes, for example, DLC materials, iron base materials, aluminum ally materials and the like.

That is, capable of being shown as the examples thereof are a case in which both of the two sliding faces are the DLC materials, a case in which one sliding face is the DLC material and in which the other sliding face is the iron base material and a case in which one sliding face is the DLC material and in which the other sliding face is the aluminum ally material.

In this connection, the DLC material described above has a DLC film on a surface. DLC constituting the above film is an amorphous material constituted principally from a carbon element, and a bonding form of carbons themselves comprises both of a diamond structure (SP₃ bond) and a graphite bond (SP₂ bond).

To be specific, it includes a-C (amorphous carbon) comprising only a carbon element, a-C:H (hydrogen amorphous carbon) containing hydrogen and MeC containing partially a metal element such as titanium (Ti), molybdenum (Mo) and the like.

Among them, a-C:H (hydrogen amorphous carbon), specifically a-C:H containing 5 to 50% of hydrogen or DLC W is preferred.

Further, DLC has preferably a graphite crystal peak in an X ray scattering spectrum.

The above DLC having a graphite crystal peak can be formed by a cathode PIG (penning ionization gauge) plasma CVD method under high density plasma environment.

On the other hand, carburized steel SCM420, SCr420 (JIS) and the like can be listed as the iron base material. A hypoeutectic aluminum ally containing 4 to 20% by mass of silicon and 1.0 to 5.0% by mass of copper or a hypereutectic aluminum ally is preferably used as the aluminum ally material. To be specific, AC2A, AC8A, ADC12, ADC14 (JIS) and the like can be listed.

Also, each surface roughness of the DLC material, the iron base material or the DLC material and the aluminum ally material each described above is suitably 0.1 μm or less in terms of an arithmetic average roughness from the viewpoint of a stability of sliding. If it is 0.1 μm or less, local scuffing is less liable to be formed, and the frictional coefficient can be inhibited from growing larger. Further, the DLC material described above has preferably a surface hardness of HV 1000 to 3500 in terms of a micro-Vickers hardness (98 mN load) and a thickness of 0.3 to 2.0 μm.

On the other hand, the iron base material described above has preferably a surface hardness of HRC 45 to 60 in terms of a Rockwell hardness (C scale). In this case, a durability of the film can be maintained even on a sliding condition of about 700 MPa under a high face pressure as is the case with a cam follower, and therefore it is effective.

Also, the aluminum ally material described above has preferably a surface hardness of HB 80 to 130 in terms of a Brinell hardness.

If a surface hardness and a thickness of the DLC material fall in the ranges described above, abrasion and peeling are inhibited. Further, a surface hardness of the iron base material is HRC 45 or more, it can be inhibited from buckling and peeling. On the other hand, a surface hardness of the aluminum ally material falls in the range described above, the aluminum ally material is inhibited from abrading.

The sliding part to which the lubricating oil composition of the present invention 1 is applied shall not specifically be restricted as long as it is a surface in which two metal surfaces are brought into contact and in which at least one of them has a low friction sliding material, and a sliding part of an internal combustion engine can be preferably listed. In this case, the very excellent low frictional property as compared with ever is obtained, and the fuel consumption saving effect is exerted, so that it is effective. The DLC member includes, for example, discoid shims and lifter crestal planes each obtained by coating DLC on a base plate of a steel material, and the iron base material includes low alloy chilled cast irons, carburized steels or thermally refined carbon steels and cam lobes prepared by using materials obtained according to optional combinations thereof.

### <Sliding Mechanism 1>

The lubricating oil composition of the present invention 1 described above can be applied preferably to a sliding mechanism 1 (invention 2) shown below.

The sliding mechanism 1 (invention 2) of the present invention is a sliding mechanism in which the lubricating oil composition described above is allowed to be present between sliding faces of two sliding members sliding with each other, wherein a DLC film containing 5 to 50 atom % of hydrogen is formed on a sliding face of at least one of the two sliding members.

The DLC film described above is more preferably a DLC film having a graphite crystal peak in an X ray scattering spectrum.

A case in which the DLC film described above is a DLC film having a graphite crystal peak in an X ray scattering spectrum shall be explained with reference to drawings.

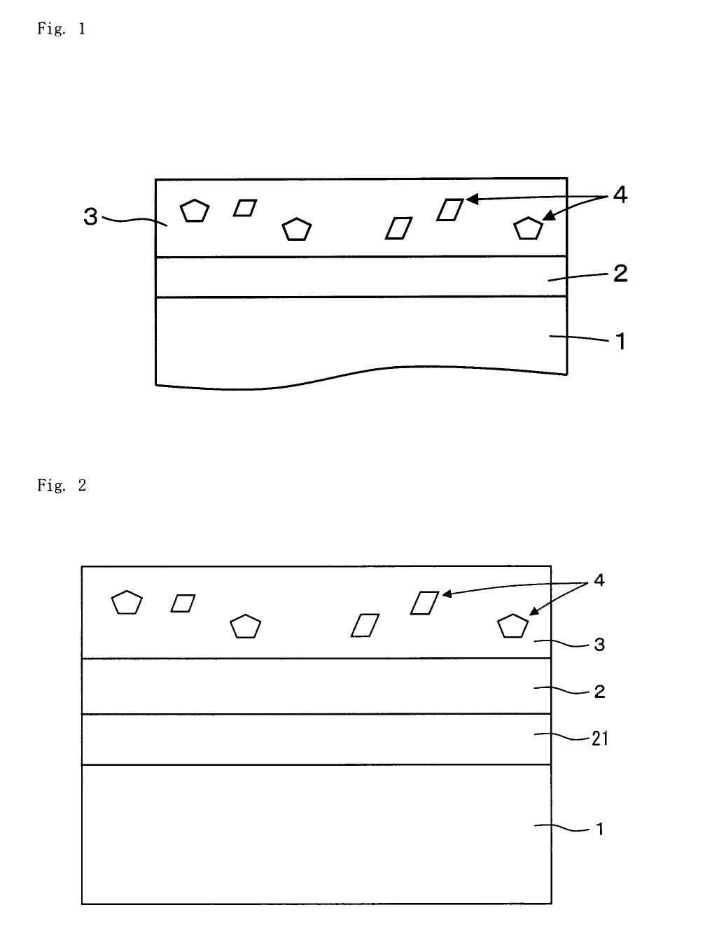

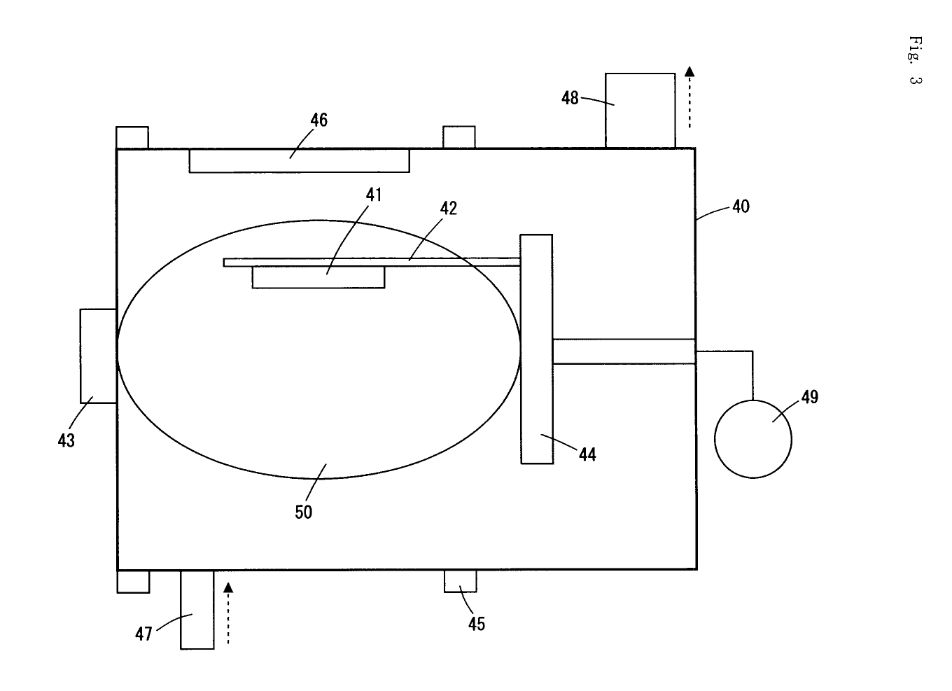

FIG. 1 is a cross-sectional drawing schematically showing the structure of the sliding member having a DLC film in the sliding mechanism 1 according to one embodiment of the present invention 2, and FIG. 2 is a cross-sectional drawing schematically showing the structure of the sliding member having a DLC film in the sliding mechanism according to another embodiment of the present invention 2.

In FIG. 1 and FIG. 2, 1 is a base material of the sliding material; 3 is the DLC film; and 4 is the graphite crystal. An intermediate layer 2 is provided as an adhesive layer between the base material 1 of the sliding material and the DLC film 3.

A base layer 21 may be provided, as shown in FIG. 2, as a second intermediate layer between the base material 1 and the intermediate layer 2. An adhesive property of the base material 1 with the intermediate layer 2 can be further enhanced by providing the base layer 21.

The above DLC film having a peak of a graphite crystal can be formed by a cathode PIG (penning ionization gauge) plasma CVD method under high density plasma environment.

To be specific, a plasma generated, for example, in a cathode PIG is shut in a magnetic field formed by a coil, whereby it is elevated in a density, and a raw material gas is decomposed into active atoms, active molecules and active ions at a high efficiency. Further, a direct current pulse is applied onto the base material while piling up the highly active raw material gas component, whereby high energy ions can be irradiated. This makes it possible to form efficiently a DLC film which is excellent in a sliding characteristic. In respect to details of the forming method, a method described in Japanese Patent Application No. 335718/2008 is preferred.

FIG. 3 is a drawing showing an outline of one example of the cathode PIG plasma CVD equipment described above. In FIG. 3, 40 is a chamber; 41 is a base material; 42 is a holder; 43 is a plasma source; 44 is an electrode; 45 is a coil; 46 is a cathode; 47 is a gas introducing port; 48 is a gas discharge port; 49 is a bias electric source; and 50 is a plasma formed in the chamber 40.

The DLC film can be formed in the following manner by using the equipment described above.

First, the base material 41 which is supported by the holder 42 is arranged in the chamber 40. Next, Ar gas is injected from the gas introducing port 47, and the plasma 50 is generated and stabilized by using the plasma source 43, the electrode 44 and the coil 45. The Ar gas decomposed in the plasma is attracted to the base material 41 by the bias electric source 49 to carry out surface etching. Then, a metal layer which is a base layer is formed by using the cathode 46 comprising metal and the Ar gas. Further, a raw material gas injected from the gas introducing port 47 under high density plasma atmosphere is decomposed and reacted to thereby form graphite crystal in the DLC film. It is maintained as it is until the DLC film having a prescribed thickness is obtained. In this case, a crystal diameter of the graphite crystal is controlled so that it is 15 to 100 nm. The crystal diameter is preferably 15 to 30 nm.

In the cathode PIG plasma CVD equipment described above, the characteristics of the DLC film obtained can be changed by changing the plasma characteristics and the gas kind, and the sliding property and the durability can be enhanced by optimizing an amount of the graphite crystal and a hardness, a surface roughness and the like of the DLC film in addition to a crystal diameter of the graphite crystal described above.

The presence of the graphite crystal in the DLC film formed and the crystal diameter are confirmed preferably by using X ray diffraction measurement shown below.

Usually, a plural number of sharp diffraction peaks corresponding to the respective lattice planes is present in an X ray diffraction spectrum of a crystal material, and a crystal structure thereof is determined usually by checking the above peaks. In contrast with this, in a case of the preferred DLC film of the present invention 2, the diffraction peaks of the graphite crystal are present among scattered broad peaks which are inherent to an amorphous material and called halo patterns.

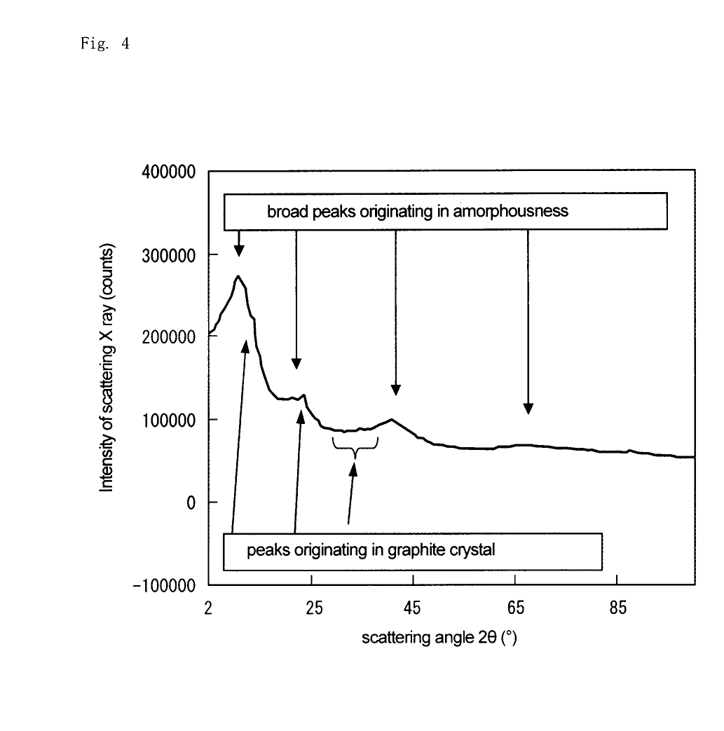

FIG. 4 shows an X ray diffraction spectrum of the DLC film containing graphite crystal which is actually measured on the following conditions:

### Measurement Conditions:

X ray source: radiant light source
X ray energy: 15 KeV
Incident slit width: 0.1 mm
Detector: scintillation counter (a solar slit is arranged in a front stage)
Measuring range of scattering angle 2θ: 5 to 100° C.
Measuring step: 0.1°
Integrated time: 30 seconds/step

The DLC film sample was peeled off from the base plate, and it was filled into a narrow glass tube (capillary) and measured.

As shown in FIG. 4, a principal component of the preferred DLC film is amorphous in the present invention 2, and therefore an intensity of a diffraction peak of the graphite crystal is relatively weak in a certain case.

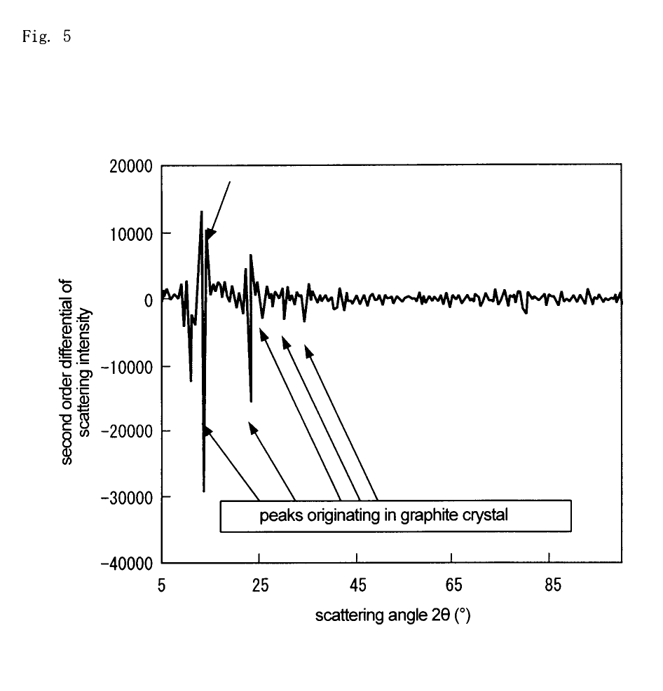

Even in the above case, the presence of the principal crystal peaks can be confirmed by using a differential spectrum which is widely used in analytical chemistry. A differential spectrum of the same DLC film sample as used in FIG. 4 is shown in FIG. 5.

In the embodiment of the present invention 2, 10 peaks are selected as the peaks observed in the differential spectrum in order from the larger ones, and if minimum 3 peaks agree with the peak positions of the graphite crystal, it is prescribed that the DLC film contains the graphite crystal. The above method is based on a Hanawalt method used in X ray diffraction of ordinary crystal materials, that is, a method for defining diffraction graphics by using 3 peaks having the largest density.

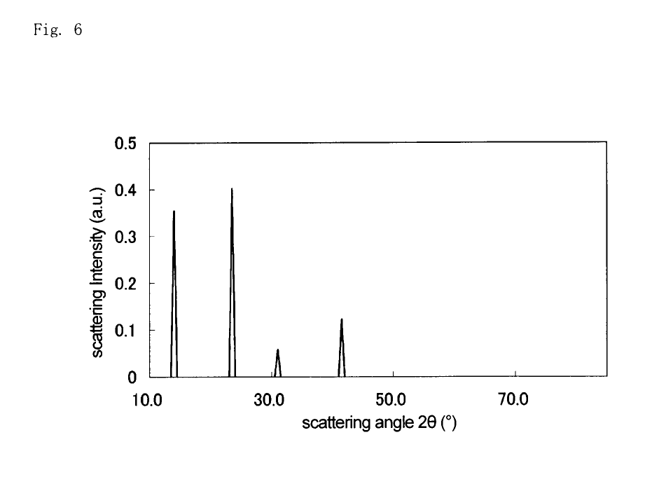

Further, a crystal diameter of the graphite crystal can be estimated from broadening of the diffraction peaks shown above. To be specific, it can be determined by deducting halo patterns given by amorphous crystal as a background from the X ray diffraction spectrum to extract graphite crystal peaks and then applying a Scherrer equation shown by Equation 1. A result obtained by extracting the graphite crystal peaks of the same DLC sample as used in FIG. 4 is shown in FIG. 6.

D=(0.9×λ)/(β×cos θ) Equation 1
D: crystal diameter (nm)
λ: wavelength of X ray (nm)
β: half value width of crystal peak (radian)
θ: position of crystal peak

The DLC film obtained has, as described above, an amorphous structure comprising carbon as a principal component, and a bonding form of carbons themselves comprises both of a diamond structure (SP³ structure) and a graphite structure (SP² structure) and contains 10 to 35 atom %, preferably 20 to 30 atom % of hydrogen in the film. If it is less than 10 atom %, the graphite crystal is reduced down to a detection limit or lower. If it exceeds 35 atom %, bonding of carbons themselves is decreased due to an increase in hydrogen ends to reduce the film hardness, and the abrasion resistance is reduced. Accordingly, both are not preferred.

In general, it is difficult to form the above DLC film on an iron base material, an aluminum alloy and the like with a good adhesive force, and therefore the intermediate layer as an adhesive layer is provided as described above. The intermediate layer is, to be specific, preferably an intermediate layer comprising any one layer or two or more layers of a metal layer, a metal nitride layer or a metal carbide layer of any metals selected from, for example, Ti, Cr, W and Si. A total thickness of the intermediate layer is preferably 0.1 to 2.0 μm. That is, if it is less than 0.1 μm, the functions of the intermediate layer are unsatisfactory. On the other hand, if it exceeds 2.0 μm, a hardness of the intermediate layer itself is low, and therefore the impact resistance and the adhesive property are likely to be reduced. Also, the base layer includes, to be specific, a film of metal selected from, for example, Ti, Cr, W and Si.

The sliding mechanism related to the present invention 2 is constituted from the lubricating oil and the sliding member each described above. Both of the lubricating oil and the sliding member have, as described above, an excellent low frictional characteristic, and therefore the sufficiently low frictional coefficient can be obtained.

In the sliding member, the DLC film described above is formed on at least one of sliding faces sliding with each other. A sliding face of the opposite material shall not specifically be restricted, and a DLC film may be formed similarly thereon or may not be formed. When the DLC film is not formed, the iron base material and the aluminum alloy material described above can be listed as the opposite material.

The sliding mechanism 1 (present invention 2) has been explained above.

The sliding mechanism 2 (present invention 3) shall be explained below.

The lubricating oil composition used in the present invention 1 described above can be preferably applied as well to the following sliding mechanism 2 (present invention 3).

### <Sliding Member>

A DLC film (called as well “a hard carbon film”) is excellent in an abrasion resistance, a burning resistance and a low frictional property, but it can not exert a satisfactory low frictional characteristic in a part of lubricating oils containing ZnDTP and the like in many cases. In the present invention 3, various DLC films have been formed and evaluated in order to meet the above problem, and as a result thereof, it has been found that the excellent low frictional characteristic can be exerted in lubricating oils containing no ZnDTP by adding W or Mo to the DLC film. This is considered to be attributable to that an additive contained in the lubricating oil composition is bonded with the atoms of W and Mo to make it easy to form a tribofilm and that the excellent low frictional characteristic is exerted.

The constitution of the DLC material in the sliding mechanism 2 (present invention 3) shall be explained with reference to FIG. 1 and FIG. 2. FIG. 1 and FIG. 2 are cross-sectional drawings schematically showing the cross-sectional constitutions of the DLC material according to other embodiments of the present inventions 2 and 3. Part names, numbers and functions thereof in FIG. 1 and FIG. 2 are the same as explained in the sliding mechanism 2 (present invention 3).

The above DLC film is an amorphous film constituted principally from a carbon element and contains 1 to 30 atom % of W or Mo.

The DLC film containing W or Mo is prepared by, for example, a method in which while forming a DLC film on a surface of a targeted member by arc deposition and a sputtering method using a graphite raw material as a target, a metal element is sputtered by arc deposition and a sputtering method using a W target or a Mo target as a raw material.

Further, in another method, it is prepared by a method in which in the method described above, a plasma CVD method for plasma-decomposing a hydrocarbon gas such as acetylene, methane and the like is used in place of arc deposition and a sputtering method using a graphite raw material as a target to form a DLC film on a surface of a member and in which a metal element is then sputtered by arc deposition and a sputtering method using a W target or a Mo target as a raw material.

The effect is observed in 1 atom % or more in terms of a content of W or Mo, and if it exceeds 30 atom %, the film is reduced in an abrasion resistance to a large extent as well as a reduction in a hardness and becomes fragile. Accordingly, a content thereof is preferably 1 to 30 atom %.

In general, it is difficult to form the above DLC film on an iron base material, an aluminum alloy and the like with a good adhesive force, and therefore the intermediate layer as an adhesive layer is provided as described above. The intermediate layer is, to be specific, preferably an intermediate layer comprising any one layer or two or more layers of a metal layer, a metal nitride layer or a metal carbide layer of any metals selected from, for example, Ti, Cr, W and Si. A total thickness of the intermediate layer is preferably 0.1 to 2.0 μm. That is, if it is less than 0.1 μm, the functions of the intermediate layer are unsatisfactory. On the other hand, if it exceeds 2.0 μm, a hardness of the intermediate layer itself is low, and therefore the impact resistance and the adhesive property are likely to be reduced. Also, the base layer includes, to be specific, a film of metal selected from, for example, Ti, Cr, W and Si.

The further low frictional characteristic can be obtained by using a DLC film having a graphite crystal peak in an X ray diffraction spectrum as the above DLC film.

A crystal diameter of the graphite crystal is preferably 15 to 100 nm.

The DLC film having a peak of a graphite crystal has been explained in the invention 2 described above.

A cathode PIG plasma CVD equipment which is one example of an equipment for forming the DLC film according to one embodiment in the invention 3 shall be explained with reference to FIG. 3.

Part names, numbers and functions thereof in FIG. 3 are the same as explained in the present invention 2 described above.

First, after supporting a base material 41 on a holder 42, an Ar gas is used to form a metal layer which is a base layer, and the above process is carried out in the same manner as in a case of the invention 2 described above.

In the invention 3, further, a raw material gas injected from a gas introducing port 47 under high density plasma atmosphere is decomposed and reacted to thereby form graphite crystal in the DLC film. It is maintained as it is until the DLC film having a prescribed thickness is obtained. Then, arc deposition and sputtering using W or Mo as a target are carried out while forming the DLC film in the above manner.

In the cathode PIG plasma CVD equipment described above, the characteristics of the DLC film obtained can be changed by changing the plasma characteristics and the gas kind, and the sliding property and the durability can be enhanced by optimizing an amount and a crystal diameter of the graphite crystal formed and a hardness, a surface roughness and the like of the DLC film.

The presence of the graphite crystal in the DLC film formed and the crystal diameter are confirmed by using X ray diffraction measurement shown below.

A plural number of sharp diffraction peaks corresponding to the respective lattice planes is present in an X ray diffraction spectrum of a crystal material, and a crystal structure thereof is determined usually by checking the above peaks. In contrast with this, in a case of the present invention, the diffraction peaks of the graphite crystal are present among scattered broad peaks which are called halo patterns inherent to an amorphous material.

FIG. 4 shows one example of an actually measured X ray diffraction spectrum of the DLC film containing graphite crystal. The measuring conditions are the same as explained in the invention 2 described above.

Relation between FIG. 4 and FIG. 5 is the same as explained in the invention 2 described above.

In the embodiment of the present invention 3, relation between peaks observed in a differential spectrum and a method for defining diffraction graphics is the same as explained in the invention 2 described above.

Further, capability of estimating a crystal diameter of the graphite crystal from broadening of the diffraction peaks described above and relation between FIG. 4 and FIG. 6 are the same as explained in the invention 2 described above.

### <Sliding Mechanism 2>

The sliding mechanism 2 according to the present invention 3 is constituted from the lubricating oil and the sliding member each described above. Both of the lubricating oil and the sliding member have, as described above, an excellent low frictional characteristic, and therefore the sufficiently low frictional coefficient can be obtained.

In the sliding member, the DLC film described above is formed on at least one of sliding faces sliding with each other. A sliding face of the opposite material shall not specifically be restricted, and the DLC film may be formed similarly thereon or may not be formed. When the DLC film is not formed, the iron base material and the aluminum alloy material can be listed as the opposite material.

Those explained in the invention 2 can be used as the iron base material and the aluminum alloy material in the invention 3.

The sliding part to which the sliding mechanism 2 of the present invention 3 is applied shall not specifically be restricted as long as it is a surface in which two metal surfaces are brought into contact and in which at least one of them has a low friction sliding material, and, for example, a sliding part of an internal combustion engine can be listed. In this case, the very excellent low friction property as compared with ever is obtained, and the fuel consumption saving effect is exerted, so that it is effective. The DLC member includes, for example, discoid shims and lifter crestal planes each obtained by coating DLC on a base plate of a steel material, and the iron base material includes low alloy chilled cast irons, carburized steels or thermally refined carbon steels and cam lobes prepared by using materials obtained according to optional combinations thereof.

### EXAMPLES

Next, the present invention shall be explained in further details with reference to examples, but the present invention shall by no means be restricted by these examples.

### Examples 1 to 3 and Comparative Examples 1 to 3

The lubricating oil compositions of the invention 1 and lubricating oil compositions for comparison each having compositions shown in Table 1 were prepared and subjected to a frictional characteristic test shown below to determine a frictional coefficient of the sliding mechanism 1. The results thereof are shown in Table 2.

### <Frictional Characteristic Test>

A reciprocating friction test equipment (SRV reciprocating friction test equipment manufactured by Optimal Inc.) was used to measure a frictional coefficient of the sliding mechanism 1 by the following method.

A disc (□24 mm×7.9 mm) on which DLC was coated (crystal particle diameter of graphite: 20 nm) was used as a test piece, and several droplets of a sample oil (lubricating oil composition) were dropped thereon. A frictional coefficient in the sliding mechanism 1 was determined on the conditions of a load of 400N, an amplitude of 1.5 mm, a frequency of 50 Hz and a temperature of 80° C. in a state in which a cylinder (□15 mm×22 mm) made of SCM420 was set on an upper part of the disc described above.

TABLE 1

| | Example | | | Comparative Example | | |
|---|---|---|---|---|---|---|
| | 1 | 2 | 3 | 1 | 2 | 3 |
| Lubricating | Balance | Balance | Balance | Balance | Balance | Balance |
| oil base oil | | | | | | |
| Sulfur- | — | — | 1.00 | — | — | — |
| containing | | | | | | |
| compound | | | | | | |
| Phosphorus- | 1.50 | 1.50 | — | — | — | — |
| zinc- | | | | | | |
| containing | | | | | | |
| compound | | | | | | |
| Zinc | — | — | — | 1.20 | 1.20 | — |
| dialkyldithio- | | | | | | |
| phosphate | | | | | | |
| (1) | | | | | | |
| Zinc | — | — | — | — | — | 1.50 |
| dialkyldithio- | | | | | | |
| phosphate | | | | | | |
| (2) | | | | | | |
| Ca sulfonate | 0.50 | 0.50 | 0.50 | 0.50 | 0.50 | 0.50 |
| Ca salicylate | 1.54 | 1.54 | 1.54 | 1.54 | 1.54 | 1.54 |
| Succinimide | 3.62 | 3.62 | 3.62 | 3.62 | 3.62 | 3.62 |
| Viscosity | 3.40 | 3.40 | 3.40 | 3.40 | 3.40 | 3.40 |
| index- | | | | | | |
| improving | | | | | | |
| agent | | | | | | |
| Pour point- | 0.50 | 0.50 | 0.50 | 0.50 | 0.50 | 0.50 |
| depressant | | | | | | |
| Antioxidant (1) | 0.80 | 0.80 | 0.80 | 0.80 | 0.80 | 0.80 |
| Antioxidant (2) | 0.50 | 0.50 | 0.50 | 0.50 | 0.50 | 0.50 |
| Rust preventive | 0.05 | 0.05 | 0.05 | 0.05 | 0.05 | 0.05 |
| Total | 100 | 100 | 100 | 100 | 100 | 100 |

(unit: % by mass)

The respective components used for preparing the lubricating oil compositions of the invention 1 and the lubricating oil compositions for comparison are shown below.

(1) Lubricating oil base oil: hydrocracked mineral oil (kinematic viscosity at 100° C.: 4.47 mm²/s)
(2) Sulfur-containing compound: bis(n-octoxycarbonylmethyl) disulfide (sulfur content: 15.8% by mass)
(3) Phosphorus-zinc-containing compound: zinc bis(n-octylthioester)phosphate (phosphorus content: 6.2% by mass, sulfur content: 10.4% by mass)
(4) Zinc dialkyldithiophospate (1): secondary alkyl type zinc dialkyldithiophospate (phosphorus content: 8.2% by mass)
(5) Zinc dialkyldithiophospate (2): secondary alkyl type zinc dialkyldithiophospate (phosphorus content: 6.5% by mass)
(6) Ca sulfonate: Ca sulfonate (Ca content: 15.2% by mass)
(7) Ca salicylate: Ca salicylate (Ca content: 7.8% by mass) (8) Succinimide: boron-non-containing polybutenylsuccinimide (nitrogen content: 2.1% by mass)
(9) Viscosity index-improving agent: polymethacrylate (weight average molecular weight: 550,000)
(10) Pour point depressant: polymethacrylate (weight average molecular weight: 69,000)
(11) Antioxidant (1): dialkyldiphenylamine (nitrogen content: 4.62% by mass)
(12) Antioxidant (2): 4,4′-methylenebis(2,5-di-tert-butylphenol)
(13) Rust preventive: N-alkylbenzotriazole

TABLE 2

| | | | | Comparative | | |
|---|---|---|---|---|---|---|
| | Example | | | Example | | |
| | 1 | 2 | 3 | 1 | 2 | 3 |
| DLC material | DLC | DLC W | DLC | DLC | DLC W | DLC |
| Reciprocating friction | 0.128 | 0.127 | 0.139 | 0.159 | 0.155 | 0.158 |
| test equipment | | | | | | |
| (frictional coefficient) | | | | | | |

The following discs were used as the disc on which DLC was coated:

DLC: DLC containing 20 atom % of hydrogen (crystal particle diameter of graphite: 20 nm)
DLC W: DLC containing (tungsten added) 20 atom of hydrogen (crystal particle diameter of graphite: 20 nm)

The intermediate layer in DLC coating comprised Ti in both of DLC and DLC W, and a total thickness thereof was 3.0 μm.

It can be found from the results shown in Table 2 that when the lubrication oil compositions of the present invention 1 are used for the disc (sliding face) on which DLC is coated, the frictional coefficient is reduced (Examples 1 to 3). In contrast with this, it can be found that when the lubrication oil compositions which do not contain the sulfur-containing compound and the phosphorus-zinc-containing compound each used in the present invention are used, the frictional coefficient can not be reduced (Comparative Examples 1 to 3).

### Examples 4 and 5 and Comparative Examples 4 and 5

Lubricating oils and sliding members were combined and subjected similarly to a frictional characteristic test to determine the frictional coefficients. The results thereof are shown in Table 3.

### (1) Lubricating Oil:

OIL 1: lubricating oil comprising the lubricating oil composition described in Example 1.

OIL 2: lubricating oil comprising the lubricating oil composition described in Comparative Example 1.

### (2) Sliding Member (Test Piece):

The disc on which the following DLC film was coated was used as the test piece:

DLC 1: DLC film (crystal particle diameter of graphite: 20 nm) having a peak of a graphite crystal in an X ray scattering spectrum, hydrogen content: 25 atom %, according to a cathode PIG plasma CVD method.

DLC 2: hydrogen-containing DLC film having no peak of a graphite crystal in an X ray scattering spectrum, hydrogen content: 30 atom %, according to a high frequency plasma CVD method.

The intermediate layer in DLC coating comprised Ti in both of DLC 1 and DLC 2, and a total thickness thereof was 3.0 μm.

TABLE 3

| | | | Comparative | |
|---|---|---|---|---|
| | Example | | Example | |
| | 4 | 5 | 4 | 5 |
| Lubricating oil | OIL 1 | OIL 1 | OIL 2 | OIL 2 |
| Sliding member | DLC 1 | DLC 2 | DLC 1 | DLC 2 |
| Frictional coefficient | 0.125 | 0.128 | 0.150 | 0.159 |

The followings can be found from the results shown in Table 3.

When the lubricating oil compositions of the present invention 1 are used for the disc (sliding face) on which DLC is coated, a frictional coefficient in the sliding mechanism 1 of the invention 2 is reduced (Examples 4 and 5). In contrast with this, when the lubricating oils comprising the lubricating oil compositions which do not contain the sulfur-containing compound and the phosphorus-zinc-containing compound each used in the present invention 1 are used, the frictional coefficient can not be reduced (Comparative Examples 4 and 5).

Further, when the lubricating oil comprising the same lubricating oil composition of the present invention 1 is used, the DLC film having a peak of a graphite crystal is more excellent in a friction-reducing effect than the DLC film having no peak of a graphite crystal (contrast of Examples 4 and 5).

### Examples 6 to 8 and Comparative Examples 6 to 10

OIL 1 used in Example 1 described above was used in Examples 6 to 8 and Comparative Example 6, and OIL 2 used in Comparative Example 1 was used in Comparative Examples 7 to 10.

Discs (□24 mm×7.9 mm) on which DLC's shown in Table 4 were coated were prepared, and the following frictional characteristic test of the sliding mechanism 2 was carried out to determine a frictional coefficient thereof. The results thereof are shown in Table 5.

### <Frictional Characteristic Test>

A reciprocating friction test equipment (SRV reciprocating friction test equipment manufactured by Optimal Inc.) was used to measure a frictional coefficient of the sliding mechanism 2 by the following method.

Several droplets of a sample oil (lubricating oil composition) were dropped on a disc (□24 mm×7.9 mm) on which DLC was coated. A frictional coefficient in the sliding mechanism 2 was determined on the conditions of a load of 400N, an amplitude of 1.5 mm, a frequency of 50 Hz and a temperature of 80° C. in a state in which a cylinder (□15 mm×22 mm) made of SCM420 was set on an upper part of the disc described above.

The intermediate layer in DLC coating comprised W in DLC 1 and comprised Mo in DLC 2, and a total thickness thereof was 3.0 μm in both cases.

TABLE 4

| DLC | Structural composition of DLC |
|---|---|
| DLC 1 | Containing 10 atom % of W and 20 atom % of hydrogen, |
| | having a graphite crystal peak |
| DLC 2 | Containing 10 atom % of Mo and 20 atom % of hydrogen |
| DLC 3 | Containing 10 atom % of W and 20 atom % of hydrogen |
| DLC 4 | Containing no metal and 20 atom % of hydrogen |

TABLE 5

| | Lubricating | | Frictional |
|---|---|---|---|
| | oil | DLC | coefficient |
| Example 6 | OIL 1 | DLC 1 | 0.122 |
| Example 7 | OIL 1 | DLC 2 | 0.126 |
| Example 8 | OIL 1 | DLC 3 | 0.125 |
| Comparative Example 6 | OIL 1 | DLC 4 | 0.128 |
| Comparative Example 7 | OIL 2 | DLC 1 | 0.151 |
| Comparative Example 8 | OIL 2 | DLC 2 | 0.159 |
| Comparative Example 9 | OIL 2 | DLC 3 | 0.158 |
| Comparative Example 10 | OIL 2 | DLC 4 | 0.159 |

It can be found from the results shown in Table 5 that the sliding mechanism 2 of the invention 3 (Examples 7 and 8) prepared by combining the lubricating oil composition of the present invention 1 with the DLC film containing W or Mo has a small frictional coefficient and that when the DLC film has further a graphite crystal peak (Example 6), the frictional coefficient is further reduced.

### INDUSTRIAL APPLICABILITY

The lubricating oil composition of the present invention 1 is applied to a sliding face comprising a low friction sliding material such as a DLC material and can provide the sliding mechanism with an excellent low frictional characteristic, and particularly when applied to internal combustion engines, they can be provided with a fuel consumption-saving effect. Further, the sliding mechanisms 1 and 2 of the present inventions 2 and 3 in which the above lubricating oil composition is allowed to be present is excellent in a low frictional property.

1. A lubricating oil composition used for a low friction sliding material, prepared by blending with an additive selected from a phosphorus-zinc-containing compound obtained by reacting a phosphorus-containing compound represented by Formula (I) with a zinc compound: 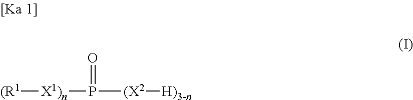
wherein X¹ and X² represent an oxygen atom or a sulfur atom; R¹ represents an organic group having 2 to 30 carbon atoms which contains an oxygen atom or a sulfur atom; and n is an integer selected from 1 to 3) and a sulfur-containing compound represented by Formula (II):
[Ka 2]
R²-A¹-Sₙ-A²-R³ (II)
(wherein n is an integer selected from 1 to 5; R² and R³ each represent independently an organic group having 1 to 30 carbon atoms which may contain an atom selected from an oxygen atom, a sulfur atom and a nitrogen atom; and A¹ and A² each represent independently a divalent hydrocarbon group having 1 to 20 carbon atoms).

2. The lubricating oil composition according to claim 1, wherein the additive is the phosphorus-zinc-containing compound obtained by using the phosphorus-containing compound in which at least one of X¹ and X² in Formula (I) is an oxygen atom.

3. The lubricating oil composition according to claim 1, wherein the additive is a phosphorus-zinc-containing compound obtained by using a phosphorus-containing compound represented by Formula (III): 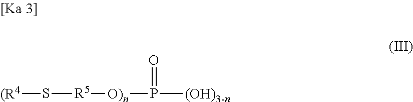
(wherein R⁴ represents an organic group having 4 to 24 carbon atoms; R⁵ represents a divalent organic group having 1 to 6 carbon atoms; and n is an integer selected from 1 to 3).

4. The lubricating oil composition according to claim 1, wherein the additive is a sulfur-containing compound represented by Formula (IV): 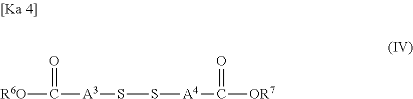
(wherein R⁶ and R⁷ each represent independently an organic group having 1 to 29 carbon atoms which may contain an atom selected from an oxygen atom, a sulfur atom and a nitrogen atom; and A³ and A⁴ each represent independently a divalent hydrocarbon group having 1 to 12 carbon atoms).

5. The lubricating oil composition according to claim 1, wherein the low friction sliding material is a material having a diamond-like carbon (DLC) film.

6. A sliding mechanism in which the lubricating oil composition according to claim 1 is allowed to be present on sliding faces of two sliding members sliding with each other, wherein a DLC film containing 5 to 50 atom % of hydrogen is formed on a sliding face of at least one of the two sliding members.

7. The sliding mechanism according to claim 6, wherein the DLC film is a DLC film having a graphite crystal peak in an X ray scattering spectrum.

8. The sliding mechanism according to claim 7, wherein a crystal diameter of the graphite crystal in the DLC film is 15 to 100 nm.

9. The sliding mechanism according to claim 7, wherein a metal layer, a metal nitride layer or a metal carbide layer comprising at least one selected from titanium (Ti), chromium (Cr), tungsten (W) and silicon (Si) is provided between the sliding member and the DLC film.

10. The sliding mechanism according to claim 7, wherein the DLC film is formed by a cathode PIG plasma CVD method under high density plasma environment.

11. A sliding mechanism in which a lubricating oil is allowed to be present on sliding faces of two sliding members sliding with each other, wherein the lubricating oil is constituted from a lubricating oil composition prepared by blending with an additive selected from a phosphorus-zinc-containing compound obtained by reacting a phosphorus-containing compound represented by Formula (I) with a zinc compound: 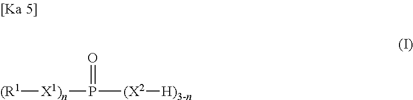
(wherein X¹ and X² represent an oxygen atom or a sulfur atom; R¹ represents an organic group having 2 to 30 carbon atoms which contains an oxygen atom or a sulfur atom; and n is an integer selected from 1 to 3) and a sulfur-containing compound represented by Formula (II):
[Ka 6]
R²-A¹-Sₙ-A²-R³ (II)
(wherein n is an integer selected from 1 to 5; R² and R³ each represent independently an organic group having 1 to 30 carbon atoms which may contain an atom selected from an oxygen atom, a sulfur atom and a nitrogen atom; and A¹ and A² each represent independently a divalent hydrocarbon group having 1 to 20 carbon atoms); a DLC film is formed on a sliding face of at least one of the two sliding members; and 1 to 30 atom % of tungsten (W) or molybdenum (Mo) is contained in the above DLC film.

12. The sliding mechanism according to claim 11, wherein an intermediate layer is provided between the sliding member and the DLC film; the above intermediate layer comprises any one layer or two or more layers of a metal layer, a metal nitride layer or a metal carbide layer of any metals selected from titanium (Ti), chromium (Cr), tungsten (W) and silicon (Si); and a total thickness of the intermediate layer is 0.1 to 2.0 μm.

13. The sliding mechanism according to claim 11, wherein the DLC film has therein a carbon layer having a graphite crystal peak in an X ray scattering spectrum.

14. The sliding mechanism according to claim 11, wherein the additive is the phosphorus-zinc-containing compound obtained by using the phosphorus-containing compound in which at least one of X¹ and X² in Formula (I) is an oxygen atom.

15. The sliding mechanism according to claim 11, wherein the additive is a phosphorus-zinc-containing compound obtained by using a phosphorus-containing compound represented by Formula (III): 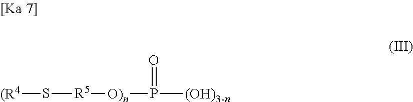
(wherein R⁴ represents an organic group having 4 to 24 carbon atoms; R⁵ represents a divalent organic group having 1 to 6 carbon atoms; and n is an integer selected from 1 to 3).

16. The sliding mechanism according to claim 11, wherein the additive is a sulfur-containing compound represented by Formula (IV): 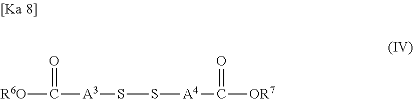
(wherein R⁶ and R⁷ each represent independently an organic group having 1 to 29 carbon atoms which may contain an atom selected from an oxygen atom, a sulfur atom and a nitrogen atom; and A³ and A⁴ each represent independently a divalent hydrocarbon group having 1 to 12 carbon atoms).
